(19) United States
(12) Patent Application Publication
(10) Pub. No.: US 2025/0050669 A1
(43) Pub. Date: Feb. 13, 2025

(54) IMAGE FORMING METHOD

(71) Applicant: BROTHER KOGYO KABUSHIKI KAISHA, Nagoya (JP)

(72) Inventors: Nozomi SUZUKI, Nisshin (JP); Sota MACHII, Miyoshi (JP)

(73) Assignee: BROTHER KOGYO KABUSHIKI KAISHA, Nagoya (JP)

(21) Appl. No.: 18/797,628

(22) Filed: Aug. 8, 2024

(30) Foreign Application Priority Data
Aug. 9, 2023 (JP) 2023-130502

(51) Int. Cl. B41M 5/035; B41M 3/00; B41M 5/00; B41M 7/00

(52) U.S. Cl. CPC B41M 5/035; B41M 3/008; B41M 5/0047; B41M 7/0081

(57) ABSTRACT

An image forming method for forming an image on a substrate, includes: forming a resin layer on the substrate; adhering a transfer sheet having a sublimable dye ink layer on a surface thereof to the resin layer, the sublimable dye ink layer including a sublimable dye ink; and heating the transfer sheet to transfer the sublimable dye ink to the resin layer. Forming the resin layer includes: ejecting a resin liquid from an inkjet head to adhere the resin liquid to the substrate, the resin liquid including a resin component capable of being polymerized by ultraviolet irradiation; and polymerizing the resin component by ultraviolet radiation to form the resin layer on the substrate.

### REFERENCE TO RELATED APPLICATIONS

This application claims priority from Japanese Patent Application No. 2023-130502 filed on Aug. 9, 2023. The entire content of the priority application is incorporated herein by reference.

### BACKGROUND ART

The present disclosure relates to an image forming method for forming an image on a substrate using thermal transfer.

In a known method of subjecting a polyvinyl chloride molded product to dye transfer by forming a cured film of an ultraviolet curable resin on the polyvinyl chloride molded product, placing sublimable dye transfer paper over this film, and performing heating under a pressure.

### SUMMARY

According to an aspect of the present disclosure, an image forming method for forming an image on a substrate, includes: forming a resin layer on the substrate; adhering a transfer sheet having a sublimable dye ink layer on a surface thereof to the resin layer, the sublimable dye ink layer including a sublimable dye ink; and heating the transfer sheet to transfer the sublimable dye ink to the resin layer. Forming the resin layer includes: ejecting a resin liquid from an inkjet head to adhere the resin liquid to the substrate, the resin liquid including a resin component capable of being polymerized by ultraviolet irradiation; and polymerizing the resin component by ultraviolet radiation to form the resin layer on the substrate.

### DESCRIPTION

As used herein, the words “a” and “an” and the like carry the meaning of “one or more.” When an amount, concentration, or other value or parameter is given as a range, and/or its description includes a list of upper and lower values, this is to be understood as specifically disclosing all integers and fractions within the given range, and all ranges formed from any pair of any upper and lower values, regardless of whether subranges are separately disclosed. Where a range of numerical values is recited herein, unless otherwise stated, the range is intended to include the endpoints thereof, as well as all integers and fractions within the range. As an example, a stated range of 1-10 fully describes and includes the independent subrange 3.4-7.2 as does the following list of values: 1, 4, 6, 10.

In JPS63-38475B, the polyvinyl chloride molded product is coated with an ultraviolet curable resin by knife coating or gravure coating. Therefore, the polyvinyl chloride molded product is limited to a sheet-shaped product, and it is difficult to perform full-color printing on a three-dimensional object such as a cup. On the other hand, it is conceivable to perform printing on a three-dimensional object by an inkjet method using an ultraviolet curable ink. However, as the print density or the color increases, the thickness of the ink film increases, resulting in poor adhesion between the three-dimensional object and the ink film, or a loss of texture on the surface of the three-dimensional object.
(1) The embodiment of the present disclosure is related to an image forming method for forming an image on a substrate. The image forming method includes a resin layer forming step of allowing a resin liquid containing a resin component capable of being polymerized by ultraviolet irradiation to adhere to the substrate by ejecting the resin liquid from an inkjet head, and fixing the resin component as a resin layer to the substrate by ultraviolet irradiation; and a transfer step of allowing a transfer sheet having a sublimable dye ink layer to adhere to the resin layer and transferring a sublimable dye ink in the sublimable dye ink layer to the resin layer by heating.

According to the above image forming method, an image having good color development and texture is formed on the substrate.
(2) The substrate may contain an inorganic material or a resin material having a glass transition point of 90° C. or higher.

Accordingly, an image without bleeding can be formed.
(3) The resin layer may have a glass transition point in a range of 0° C. to 70° C.

Accordingly, the transfer sheet has excellent peelability.
(4) The resin layer may have a thickness in a range of 5 μm to 50 μm.

Accordingly, the image has good color development and adhesion between the substrate and the resin layer is good.
(5) The resin liquid may contain a first resin liquid containing a first resin component and a second resin liquid containing a second resin component, the resin layer forming step may include a first step of allowing the first resin liquid to adhere to the substrate by ejecting the first resin liquid from an inkjet head and fixing the first resin component as a base layer on the substrate by ultraviolet irradiation, and a second step of allowing the second resin liquid to adhere to the base layer by ejecting the second resin liquid from an inkjet head and laminating the second resin component as a surface layer on the base layer by ultraviolet irradiation, and the base layer may have a glass transition point lower than a glass transition point of the surface layer.

Accordingly, the adhesion between the base layer and the substrate is good, and the peelability of the transfer sheet on the surface layer is good.
(6) The glass transition point of the base layer may be lower than 25° C., and the glass transition point of the surface layer may be in a range of 25° C. to 55° C.
(7) The surface layer may have a thickness of 15 μm or more.

Accordingly, the image has good color development.
(8) The resin liquid may further contain a third resin liquid containing the resin component the third resin liquid may contain a coloring material the first resin liquid and the second resin liquid may contain no coloring material, and the resin layer forming step may include, after the first step and before the second step, a third step of allowing the third resin liquid to adhere to the base layer by ejecting the third resin liquid from an inkjet head and forming an intermediate layer between the base layer and the surface layer by ultraviolet irradiation.

Accordingly, the adhesion between the base layer and the substrate is good, and the peelability of the transfer sheet on the surface layer is good. In addition, the image has good color development.
(10) In the transfer step, a heating temperature when transferring the sublimable dye ink in the sublimable dye ink layer to the resin layer may be in a range of 120° C. to 240° C.

According to the present invention, an image having good color development is formed on a substrate using thermal transfer, and the texture of the substrate is not impaired.

Hereinafter, a preferred embodiment of the present disclosure will be described. Note that, the present embodiment is merely one embodiment of the present disclosure, and it is needless to say that the embodiment can be modified without changing the gist of the present invention.

An image forming method for forming an image on a substrate includes a resin layer forming step and a transfer step. The substrate is not limited as long as a resin layer can be laminated thereon, and examples thereof include paper, cloth, wood, a glass, a metal, and a resin. In addition, the substrate may be made of two or more materials. The shape of the substrate is not limited, and may be a sheet or a flat plate, or a three-dimensional object with various shapes. It is preferable that the surface of the substrate on which the image is to be formed is an inorganic material or a resin material having a glass transition point of 90° C. or higher since an image without bleeding can be formed. Examples of the inorganic material include a glass and a metal. Examples of the resin material having a glass transition point (Tg) of 90° C. or higher include polymethyl methacrylate (Tg=90° C.), a polystyrene (Tg=100° C.), polyacrylonitrile (Tg=104° C.), a polyacrylic acid (Tg=106° C.), a polycarbonate (Tg=150° C.), a polymethacrylic acid (Tg=185° C.), and a copolymer thereof.

In the resin layer forming step, a resin liquid containing a resin component that undergoes polymerization by ultraviolet irradiation adheres to a substrate by being ejected from an inkjet head, and the resin component is fixed as a resin layer to the substrate by ultraviolet irradiation.

As the resin component that undergoes polymerization by ultraviolet irradiation, a known resin component is used. Examples of the known resin component include polymerizable oligomers such as epoxy acrylate, polyester urethane acrylate, and polyester acrylate, polymerizable monomers such as 2-ethylhexyl (meth)acrylate, 2-hydroxyethyl (meth)acrylate, 2-hydroxypropyl (meth)acrylate, 1,3-butanediol di(meth)acrylate, 1,6-hexanediol di(meth)acrylate, diethylene glycol di(meth)acrylate, neopentyl glycol di(meth)acrylate, trimethylolpropane tri(meth)acrylate, and pentaerythritol tri(meth)acrylate, acetophenone, 2,2-diethoxyacetophenone, benzophenone, Michler's ketone, benzyl, a benzoin alkyl ether, benzyl methyl ketal, and thioxane. One or more of these resin components are selected and adjusted appropriately such that the glass transition point of the resin layer after polymerization by ultraviolet irradiation falls within a predetermined range to form a resin liquid. The resin liquid contains a photopolymerization initiation aid, a surfactant, and the like as necessary. The glass transition point of the resin layer is preferably within a range of 0° C. to 70° C. Among them, a range of 25° C. to 55° C. is preferred, a range of 38° C. to 55° C. is more preferred, and a range of 49° C. to 55° C. is particularly preferred. When the glass transition point of the resin layer is within the above range, peelability of the transfer sheet in the transfer step is excellent.

The resin layer formed from the resin component that undergoes polymerization by ultraviolet irradiation may have two or more resin layers. The two or more resin layers are, for example, two layers or three layers. When the resin layer has two layers (a base layer and a surface layer), the glass transition point of the base layer is preferably lower than 25° C., and particularly preferably lower than 16° C. When the glass transition point of the base layer is within the above range, adhesion between the substrate and the base layer is good.

The glass transition point of the surface layer is preferably within a range of 25° C. to 55° C., more preferably within a range of 38° C. to 55° C., and particularly preferably within a range of 49° C. to 55° C. When the glass transition point of the surface layer is within the above range, the peelability of the transfer sheet in the transfer step is excellent.

When the resin layer has three layers (a base layer, an intermediate layer, and a surface layer), a resin component forming the intermediate layer may be the same as a resin component forming the surface layer. In addition, a resin liquid forming the intermediate layer may contain a coloring material, and a resin liquid forming the base layer and the surface layer may not contain a coloring material. When the resin layer has two layers (a base layer and a surface layer), a resin liquid forming the base layer may contain a coloring material. The coloring material is preferably, for example, a white pigment, but is not limited to white. Accordingly, the adhesion between the base layer and the substrate is good, the surface layer has good peelability of the transfer sheet, and the intermediate layer or the base layer is colored. Therefore, the image transferred to the surface layer has good color development.

The white pigment is preferably, for example, zinc oxide (C.I. Pigment White (hereinafter also referred to as “CIPW”) 4), titanium oxide (CIPW 6), zinc sulfide (CIPW 7), zirconium oxide (zirconium white, CIPW 12), calcium carbonate (CIPW 18), aluminum oxide/silicon oxide (kaolin clay, CIPW 19), barium sulfate (CIPW 21 or 22), aluminum hydroxide (alumina white, CIPW 23), silicon oxide (CIPW 27), and calcium silicate (CIPW 28). Inorganic particles for use in the white pigment may be single particles, or may be composite particles with oxides of silicon, aluminum, zirconium, titanium, or the like, organometallic compounds, and organic compounds. Among them, titanium oxide is suitable for use because of having a lower specific gravity and a higher refractive index than other white pigments, and thus having excellent concealment and coloring properties for the substrate, and excellent durability against acids, alkalis, and other environments. Note that, in addition to titanium oxide, other white pigments (other than the above white pigments) may be used in combination.

The resin liquid adheres to the substrate or the already formed resin layer by being ejected from an inkjet head toward the substrate. The inkjet head is one that ejects minute droplets through a nozzle, and a known inkjet head is used. The resin liquid may be applied to cover the entire substrate or resin layer, or may be applied only to a part of the substrate or the resin layer. Then, the resin liquid adhering to the substrate or the resin layer is subjected to ultraviolet irradiation to cure the resin component, and a resin layer is formed. When two or more resin layers are formed, for example, ejection of the resin liquid from the inkjet head and the ultraviolet irradiation are repeatedly performed in order for the base layer, the intermediate layer, and the surface layer.

The overall thickness of the resin layer is preferably within a range of 5 μm to 50 μm. Among them, a range of 10 μm to 50 μm is preferred, and a range of 43 μm to 50 μm is more preferred. When the thickness of the resin layer is within the above range, the image has good color development.

In addition, when the resin layer has two or more layers, the thickness of the surface layer is preferably within a range of 15 μm to 45 μm. When the thickness of the surface layer is within the above range, the image has good color development, and the texture of the substrate is maintained.

In the transfer step, a transfer sheet having a sublimable dye ink layer adheres to the resin layer, and a sublimable dye ink in the sublimable dye ink layer is transferred to the resin layer by heating. After the transfer, the transfer sheet is peeled off from the resin layer.

The transfer sheet having a sublimable dye ink layer is formed by a known method. Examples of a substrate for the transfer sheet include paper and a resin. A sublimable dye ink layer having a desired image is formed by ejecting, from an inkjet head or the like, a dye ink onto a sheet serving as a substrate. The dye ink contains a disperse dye that sublimates upon heating, and dye inks with two or more colors may be used.

The sublimable dye ink contains water, a water-soluble organic solvent, and a sublimable dye. The sublimable dye is also called a disperse dye. Examples of the sublimable dye include: C.I. Disperse Red 60; C.I. Disperse Yellow 3, 7, 8, 23, 39, 51, 54, 60, 71, and 86; C.I. Disperse Orange 1, 1:1, 5, 20, 25, 25:1, 33, 56, and 76; C.I. Disperse Brown 2; C.I. Disperse Red 11, 50, 53, 55, 55:1, 59, 60, 65, 70, 75, 93, 146, 158, 190, 190:1, 207, 239, and 240; C.I. Vat Red 41; C.I. Disperse Violet 8, 17, 23, 27, 28, 29, 36, and 57; C.I. Disperse Blue 19, 26, 26:1, 35, 55, 56, 58, 64, 64:1, 72, 72:1, 81, 81:1, 91, 95, 108, 131, 141, 145, and 359; and C.I. Solvent Blue 36, 63, 105, and 111. These may be used alone or in combination of two or more thereof. In addition, the dye ink may contain components other than those described above (other components). Examples of other components include a dispersant, a preservative and fungicide, a pH adjuster, a chelating reagent, a rust preventive, an ultraviolet absorber, an antifoaming agent, and a surface tension adjuster.

The heating temperature when transferring the dye ink to the resin layer is preferably within a range of 120° C. to 240° C. When the heating temperature is lower than the above range, the transfer efficiency deteriorates. When the heating temperature is higher than the above range, the image may be blurred or the resin layer may deteriorate, influencing the image. The transfer time is not limited, and is, for example, 30 seconds.

### EXAMPLES

Hereinafter, Examples of the present disclosure will be described.

### Example 1

A resin liquid A, which was adjusted such that the glass transition point of the resin layer polymerized by ultraviolet irradiation was 38° C., was sprayed onto a glass-made flat plate in a rectangular shape of 20 mm×50 mm using an inkjet printer (GTX pro manufactured by Brother Industries, Ltd.), and was subjected to ultraviolet irradiation to form a resin layer having a thickness of 15 μm. A transfer sheet, in which a sublimable dye ink (C.I. Disperse Red 60) was laminated on a paper-made sheet, was placed over the formed resin layer, followed by heating at 160° C. for 30 seconds using a small hand-operated iron press Kabuto PCA-3233, and natural cooling. Then, the transfer sheet was peeled off from the resin layer to form a rectangular filled image on the substrate. That is, the sublimable dye ink was sublimated and transferred from the transfer sheet to the resin layer. The glass transition point of the resin layer was measured using an irradiation differential scanning calorimeter DSC7000X (manufactured by Hitachi High-Tech Corporation).

### Example 2

An image was formed in the same manner as in Example 1, except that a resin liquid B adjusted such that the glass transition point of the resin layer polymerized by ultraviolet irradiation was 27° C. was used, and the thickness of the resin layer was 20 μm.

### Example 3

An image was formed in the same manner as in Example 2, except that the thickness of the resin layer was 10 μm.

### Example 4

An image was formed in the same manner as in Example 2, except that the thickness of the resin layer was 50 μm.

### Example 5

An image was formed in the same manner as in Example 1, except that a resin liquid C containing CIPW 6 (titanium oxide) and adjusted such that the glass transition point of the resin layer polymerized by ultraviolet irradiation was 50° C. was used, and the thickness of the resin layer was 10 μm.

### Example 6

A resin liquid E, which was adjusted such that the glass transition point of the resin layer polymerized by ultraviolet irradiation was 21° C., was sprayed onto a flat plate glass in a rectangular shape of 20 mm×50 mm using an inkjet printer (GTX pro manufactured by Brother Industries, Ltd.), and was subjected to ultraviolet irradiation to form a base layer having a thickness of 3 μm. Further, a resin liquid D, which was adjusted such that the glass transition point of the resin layer polymerized by ultraviolet irradiation was 49° C., adhered to the base layer using an inkjet printer, and was subjected to ultraviolet irradiation to form a surface layer having a thickness of 10 μm. Thereafter, an image was formed using a transfer sheet in the same manner as in Example 1.

### Example 7

A resin liquid F, which was adjusted such that the glass transition point of the resin layer polymerized by ultraviolet irradiation was 15° C., was sprayed onto a flat plate glass in a rectangular shape of 20 mm×50 mm using an inkjet printer (GTX pro manufactured by Brother Industries, Ltd.), and was subjected to ultraviolet irradiation to form a base layer having a thickness of 3 μm. Further, the resin liquid A adhered to the base layer using an inkjet printer, and was subjected to ultraviolet irradiation to form a surface layer having a thickness of 10 μm. Thereafter, an image was formed using a transfer sheet in the same manner as in Example 1.

### Example 8

An image was formed in the same manner as in Example 6, except that the resin liquid D adhered to the base layer using an inkjet printer (GTX pro manufactured by Brother Industries, Ltd.), and was subjected to ultraviolet irradiation to form a surface layer having a thickness of 15 μm.

### Example 9

An image was formed in the same manner as in Example 8, except that the thickness of the surface layer was 20 μm.

### Example 10

The resin liquid F was sprayed onto a metal-made flat plate in a rectangular shape of 20 mm×50 mm using an inkjet printer (GTX pro manufactured by Brother Industries, Ltd.), and was subjected to ultraviolet irradiation to form a base layer having a thickness of 3 μm. Further, the resin liquid D adhered to the base layer using an inkjet printer, and was subjected to ultraviolet irradiation to form a surface layer having a thickness of 40 μm. Thereafter, an image was formed using a transfer sheet in the same manner as in Example 1.

### Example 11

The resin liquid E was sprayed onto a metal-made flat plate in a rectangular shape of 20 mm×50 mm using an inkjet printer (GTX pro manufactured by Brother Industries, Ltd.), and was subjected to ultraviolet irradiation to form a base layer having a thickness of 1 μm. Further, a resin liquid G, which was adjusted such that the glass transition point of the resin layer polymerized by ultraviolet irradiation was 52° C., adhered to the base layer using an inkjet printer, and was subjected to ultraviolet irradiation to form a surface layer having a thickness of 20 μm. Thereafter, a transfer sheet same as in Example 1 was heated at 90° C. for 30 seconds, and after natural cooling, the transfer sheet was peeled from the resin layer to form a rectangular filled image on the substrate.

### Example 12

An image was formed in the same manner as in Example 11, except that the heating temperature for the transfer sheet was 250° C.

### Example 13

The resin liquid E was sprayed onto a flat plate made of a polycarbonate (Tg=150° C.) in a rectangular shape of 20 mm×50 mm using an inkjet printer (GTX pro manufactured by Brother Industries, Ltd.), and was subjected to ultraviolet irradiation to form a base layer having a thickness of 1 μm. Further, the resin liquid G adhered to the base layer using an inkjet printer, and was subjected to ultraviolet irradiation to form a surface layer having a thickness of 20 μm. Thereafter, a transfer sheet same as in Example 1 was heated at 160° C. for 30 seconds, and after natural cooling, the transfer sheet was peeled from the resin layer to form a rectangular filled image on the substrate.

### Example 14

An image was formed in the same manner as in Example 7, except that a flat plate made of vinyl chloride (Tg=87° C.) was used as the substrate.

### Example 15

An image was formed in the same manner as in Example 7, except that the resin liquid C adhered to the base layer using an inkjet printer (GTX pro manufactured by Brother Industries, Ltd.), and was subjected to ultraviolet irradiation to form a surface layer having a thickness of 10 μm.

### Example 16

The resin liquid C was sprayed onto a flat plate glass in a rectangular shape of 20 mm×50 mm using an inkjet printer (GTX pro manufactured by Brother Industries, Ltd.), and was subjected to ultraviolet irradiation to form a base layer having a thickness of 10 μm. Further, the resin liquid D adhered to the base layer using an inkjet printer, and was subjected to ultraviolet irradiation to form a surface layer having a thickness of 10 μm. Thereafter, an image was formed using a transfer sheet in the same manner as in Example 1.

### Example 17

The resin liquid F was sprayed onto a flat plate glass in a rectangular shape of 20 mm×50 mm using an inkjet printer (GTX pro manufactured by Brother Industries, Ltd.), and was subjected to ultraviolet irradiation to form a base layer having a thickness of 3 μm. Further, the resin liquid C adhered to the base layer using an inkjet printer, and was subjected to ultraviolet irradiation to form an intermediate layer having a thickness of 3 μm. Further, the resin liquid D adhered to the intermediate layer using an inkjet printer, and was subjected to ultraviolet irradiation to form a surface layer having a thickness of 10 μm. Thereafter, an image was formed using a transfer sheet in the same manner as in Example 1.

### Comparative Example 1

A resin liquid further containing a magenta pigment (PR122) in the resin liquid B was sprayed onto a glass-made flat plate in a rectangular shape of 20 mm×50 mm using an inkjet printer (GTX pro manufactured by Brother Industries, Ltd.), and was subjected to ultraviolet irradiation to form a rectangular filled image.

### Comparative Example 2

An image was formed in the same manner as in Comparative Example 1, except that the thickness of the resin layer was 100 μm.

### Comparative Example 3

A sublimation transfer ink was directly sprayed onto a glass-made flat plate in a rectangular shape of 20 mm×50 mm using an inkjet printer (GTX pro manufactured by Brother Industries, Ltd.) and sublimation was performed to form a filled image. The sublimation conditions were 200° C. and 30 seconds. That is, sublimation transfer using a transfer sheet was not performed.

### Comparative Example 4

The resin liquid F was sprayed onto a glass-made flat plate in a rectangular shape of 20 mm×50 mm using an inkjet printer (GTX pro manufactured by Brother Industries, Ltd.), and was subjected to ultraviolet irradiation to form a base layer having a thickness of 5 μm. Further, the resin liquid B was sprayed onto the base layer using an inkjet printer, and was subjected to ultraviolet irradiation to form a surface layer having a thickness of 20 μm. A sublimation transfer ink was directly sprayed onto the surface layer using an inkjet printer and sublimation was performed to form a filled image. The sublimation conditions were 200° C. and 30 seconds. That is, sublimation transfer using a transfer sheet was not performed.

### Color Development Test

The optical density (OD value) at three locations in the formed image was measured using a spectrophotometer SpectoroEye (light source: D50, viewing angle: 2°, ANSI-T) manufactured by X-Rite, and the average value was obtained and evaluated based on the following evaluation criteria. AA: 2.0 or more
A: 1.5 or more and less than 2.0
B: 1.0 or more and less than 1.5
C: less than 1.5 or no color development

### Bleeding Test

Whether there was any bleeding in the formed image was visually determined based on the following evaluation criteria.
A: no bleeding at all
B: some bleeding
C: bleeding

### Peelability Test

The peelability of the transfer sheet when an image was formed using the transfer sheet was evaluated based on the following criteria. AA: easy peeling off can be made
A: some peeling marks remain on the resin layer
B: many peeling marks remain on the resin layer
C: peeling off cannot be made

### Adhesion Test

A cellophane tape (CT-12 manufactured by NICHIBAN Co., Ltd.) was firmly stuck to the surface of the resin layer, and when it was peeled off at once, a residual rate of the resin layer was evaluated based on the following criteria. AA: 90% or more of the resin layer remains
A: 70% or more of the resin layer remains
B: 50% or more of the resin layer remains
C: less than 50% of the resin layer remains

### Texture Test

The presence or absence of the texture of the substrate on which the image was formed was visually determined.
o: the texture of the substrate remains
x: the texture of the substrate does not remain

### Substrate Color Concealment Test

Whether the color of the substrate on which the image was formed was concealed was visually determined.

### Color Development Test Evaluation

As shown in Table 1 to Table 3, it can be seen that Examples 1 to 17 have more excellent color development than Comparative Examples 1 and 4. In Examples 2, 4, 8 to 10, 13, 16, and 17, in which the total thickness of the resin layer is 16 μm or more, the evaluation is A or more and the color development is excellent.

### Bleeding Test Evaluation

It can be seen that Examples 1 to 13 and 15 to 17, in which the material of the substrate is a glass, a metal, or a polycarbonate (Tg=150° C.), have less bleeding than Example 14, in which the material of the substrate is vinyl chloride (Tg=87° C.).

### Peelability Test Evaluation

It can be seen that Examples 1 and 5 to 17, in which the glass transition point (Tg) of the surface layer is 38° C. or higher, have more excellent peelability of the transfer sheet than Examples 2 to 4, in which the glass transition point (Tg) of the surface layer is 27° C. It is thought that when the glass transition point of the surface layer is high, the surface layer is hard and the adhesive force decreases, so that the transfer sheet has excellent peelability. It is thought that when the glass transition point of the surface layer is low, the surface layer is soft and the adhesive force increases, so that the transfer sheet has poor peelability.

### Adhesion Test Evaluation

It can be seen that, among Examples 6 to 17 in which the resin layer has two layers or three layers, Examples 6 to 15 and 17, in which the glass transition point of the base layer is lower than the glass transition point of the surface layer, have more excellent adhesion of the resin layer to the substrate than Example 16, in which the glass transition point of the base layer is higher than the glass transition point of the surface layer. The resin layer polymerized by ultraviolet irradiation shrinks due to the polymerization, and therefore an internal stress is generated. It is thought that when the thickness of the resin layer increases, the internal stress increases, resulting in poor adhesion. In addition, it is thought that when the glass transition point of the base layer is higher than the glass transition point of the surface layer, the crosslinking density, which has a correlation with the glass transition point, increases, resulting in poor adhesion.

### Texture Test Evaluation

It can be seen that in Examples 1 to 17, in which the total thickness of the resin layers is 10 μm to 50 μm, the texture of the substrate is maintained as compared to Comparative Example 2, in which the total thickness of the resin layers is 100 μm. In addition, in Examples 1 to 17, the resin layer is formed by selective spraying onto the substrate using an inkjet head, so that the device can be made smaller compared to powder coating in the related art. Since the resin layer can be selectively formed on the substrate, the texture of the substrate can be maintained. The resin liquid is used efficiently only where it is needed.

### Substrate Color Concealment Test Evaluation

It can be seen that in Examples 5 and 15 to 17, in which the resin liquid forming the resin layer contains a pigment, the substrate color is concealed. When the substrate color is concealed, an image can be obtained by sublimation transfer by forming a resin layer on a dark-colored substrate only at the location where the image is desired to be formed. In addition, it can be seen that, among Examples 5 and 15 to 17, Examples 16 and 17, in which the resin liquid forming the surface layer does not contain a pigment, have more excellent color development than Examples 5 and 15, in which the resin liquid forming the surface layer contains a pigment.

TABLE 1

| | | | Example 1 | Example 2 | Example 3 | Example 4 | Example 5 |
|---|---|---|---|---|---|---|---|
| Image forming method | | | UV + | UV + | UV + | UV + | UV + |
| | | | sublimation | sublimation | sublimation | sublimation | sublimation |
| | | | transfer | transfer | transfer | transfer | transfer |
| Substrate | | | Glass | Glass | Glass | Glass | Glass |
| Resin layer | Surface layer | Glass transition point | 38° C. | 27° C. | 27° C. | 27° C. | 50° C. |
| | | (Tg) of resin layer | | | | | |
| | | Thickness (μm) of | 15 | 20 | 10 | 50 | 10 |
| | | coating film | | | | | |
| | | Pigment | — | — | — | — | ∘ |
| | Intermediate | Glass transition point | — | — | — | — | — |
| | | (Tg) of resin layer | | | | | |
| | layer | Thickness (μm) of | — | — | — | — | — |
| | | coating film | | | | | |
| | | Pigment | — | — | — | — | — |
| | Base layer | Glass transition point | — | — | — | — | — |
| | | (Tg) of resin layer | | | | | |
| | | Thickness (μm) of | — | — | — | — | — |
| | | coating film | | | | | |
| | | Pigment | — | — | — | — | — |
| | Overall | Total thickness (μm) | 15 | 20 | 10 | 50 | 10 |
| | | of coating film | | | | | |
| Transfer | | Transfer temperature | 160 | 160 | 160 | 160 | 160 |
| condition | | (° C.) | | | | | |
| | | Transfer time (sec) | 30 | 30 | 30 | 30 | 30 |

| | | | | | | |
|---|---|---|---|---|---|---|
| Evaluation | Color development | B | A | B | AA | B |
| | Bleeding | A | A | A | A | A |
| | Transfer sheet peelability | A | B | B | B | AA |
| | Adhesion | B | B | B | B | B |
| | Maintaining of texture of substrate | ∘ | ∘ | ∘ | ∘ | ∘ |
| | Substrate color concealment | — | — | — | — | ∘ |

| | | | Example 6 | Example 7 | Example 8 | Example 9 |
|---|---|---|---|---|---|---|
| Image forming method | | | UV + | UV + | UV + | UV + |
| | | | sublimation | sublimation | sublimation | sublimation |
| | | | transfer | transfer | transfer | transfer |
| Substrate | | | Glass | Glass | Glass | Metal |
| Resin layer | Surface layer | Glass transition point | 49° C. | 38° C. | 49° C. | 49° C. |
| | | (Tg) of resin layer | | | | |
| | | Thickness (μm) of | 10 | 10 | 15 | 20 |
| | | coating film | | | | |
| | | Pigment | — | — | — | — |
| | Intermediate | Glass transition point | — | — | — | — |
| | | (Tg) of resin layer | | | | |
| | layer | Thickness (μm) of | — | — | — | — |
| | | coating film | | | | |
| | | Pigment | — | — | — | — |
| | Base layer | Glass transition point | 21° C. | 15° C. | 21° C. | 21° C. |
| | | (Tg) of resin layer | | | | |
| | | Thickness (μm) of | 3 | 3 | 3 | 3 |
| | | coating film | | | | |
| | | Pigment | — | — | — | — |
| | Overall | Total thickness (μm) | 13 | 13 | 20 | 25 |
| | | of coating film | | | | |
| Transfer | | Transfer temperature | 160 | 160 | 160 | 160 |
| condition | | (° C.) | | | | |
| | | Transfer time (sec) | 30 | 30 | 30 | 30 |

| | | | | | |
|---|---|---|---|---|---|
| Evaluation | Color development | B | B | A | A |
| | Bleeding | A | A | A | A |
| | Transfer sheet peelability | AA | A | AA | AA |
| | Adhesion | A | AA | A | A |
| | Maintaining of texture of substrate | ∘ | ∘ | ∘ | ∘ |
| | Substrate color concealment | — | — | — | — |

TABLE 2

| | | | Example 10 | Example 11 | Example 12 | Example 13 | Example 14 |
|---|---|---|---|---|---|---|---|
| Image forming method | | | UV + | UV + | UV + | UV + | UV + |
| | | | sublimation | sublimation | sublimation | sublimation | sublimation |
| | | | transfer | transfer | transfer | transfer | transfer |
| Substrate | | | Metal | Metal | Metal | Polycarbonate | Vinyl chloride |
| Resin layer | Surface layer | Glass transition point | 49° C. | 52° C. | 52° C. | 52° C. | 38° C. |
| | | (Tg) of resin layer | | | | | |
| | | Thickness (μm) of | 40 | 20 | 20 | 20 | 10 |
| | | coating film | | | | | |
| | | Pigment | — | — | — | — | — |
| | Intermediate | Glass transition point | — | — | — | — | — |
| | layer | (Tg) of resin layer | | | | | |
| | | Thickness (μm) of | — | — | — | — | — |
| | | coating film | | | | | |
| | | Pigment | — | — | — | — | — |
| | Base layer | Glass transition point | 15° C. | 21° C. | 21° C. | 21° C. | 15° C. |
| | | (Tg) of resin layer | | | | | |
| | | Thickness (μm) of | 3 | 1 | 1 | 1 | 3 |
| | | coating film | | | | | |
| | | Pigment | — | — | — | — | — |
| | Overall | Total thickness (μm) | 43 | 20 | 20 | 20 | 13 |
| | | of coating film | | | | | |
| Transfer | | Transfer temperature | 160 | 90 | 250 | 160 | 160 |
| condition | | (° C.) | | | | | |
| | | Transfer time (sec) | 30 | 30 | 30 | 30 | 30 |

| | | | | | | |
|---|---|---|---|---|---|---|
| Evaluation | Color development | AA | B | B | A | B |
| | Bleeding | A | A | B | A | C |
| | Transfer sheet peelability | AA | AA | AA | AA | A |
| | Adhesion | AA | A | A | A | B |
| | Maintaining of texture of substrate | ∘ | ∘ | ∘ | ∘ | ∘ |
| | Substrate color concealment | — | — | — | — | — |

| | | | Example 15 | Example 16 | Example 17 |
|---|---|---|---|---|---|
| Image forming method | | | UV + | UV + | UV + |
| | | | sublimation | sublimation | sublimation |
| | | | transfer | transfer | transfer |
| Substrate | | | Glass | Glass | Glass |
| Resin layer | Surface layer | Glass transition point | 50° C. | 49° C. | 49° C. |
| | | (Tg) of resin layer | | | |
| | | Thickness (μm) of | 10 | 10 | 10 |
| | | coating film | | | |
| | | Pigment | ∘ | — | — |
| | Intermediate | Glass transition point | — | — | 50° C. |
| | layer | (Tg) of resin layer | | | |
| | | Thickness (μm) of | — | — | 3 |
| | | coating film | | | |
| | | Pigment | — | — | ∘ |
| | Base layer | Glass transition point | 15° C. | 50° C. | 15° C. |
| | | (Tg) of resin layer | | | |
| | | Thickness (μm) of | 3 | 10 | 3 |
| | | coating film | | | |
| | | Pigment | — | ∘ | — |
| | Overall | Total thickness (μm) | 13 | 20 | 16 |
| | | of coating film | | | |
| Transfer | | Transfer temperature | 160 | 160 | 160 |
| condition | | (° C.) | | | |
| | | Transfer time (sec) | 30 | 30 | 30 |

| | | | | |
|---|---|---|---|---|
| Evaluation | Color development | B | A | A |
| | Bleeding | A | A | A |
| | Transfer sheet peelability | AA | AA | AA |
| | Adhesion | AA | B | AA |
| | Maintaining of texture of substrate | ∘ | ∘ | ∘ |
| | Substrate color concealment | ∘ | ∘ | ∘ |

TABLE 3

| | | | Comparative | Comparative | Comparative | Comparative |
|---|---|---|---|---|---|---|
| | | | Example 1 | Example 2 | Example 3 | Example 4 |
| Image forming method | | | UV ink direct | UV ink direct | Sublimation | UV + |
| | | | printing | printing | ink direct | sublimation ink |
| | | | | | printing | direct printing |
| Substrate | | | Glass | Glass | Glass | Glass |
| Resin layer | Surface layer | Glass transition point | 27° C. | 27° C. | — | 27° C. |
| | | (Tg) of resin layer | | | | |
| | | Thickness (μm) of | 20 | 100 | — | 20 |
| | | coating film | | | | |
| | | Pigment | ∘ | ∘ | — | — |
| | Intermediate | Glass transition point | | | | |
| | layer | (Tg) of resin layer | | | | |
| | | Thickness (μm) of | | | | |
| | | coating film | | | | |
| | | Pigment | | | | |
| | Base layer | Glass transition point | — | — | — | 15° C. |
| | | (Tg) of resin layer | | | | |
| | | Thickness (μm) of | — | — | — | 5 |
| | | coating film | | | | |
| | | Pigment | — | — | — | — |
| | Overall | Total thickness (μm) | 20 | 100 | — | 25 |
| | | of coating film | | | | |
| Transfer | | Transfer temperature | — | — | 200 | 200 |
| condition | | (° C.) | | | | |
| | | Transfer time (sec) | | | 30 | 30 |

| | | | | | |
|---|---|---|---|---|---|
| Evaluation | Color development | C | A | C | C |
| | Bleeding | A | A | — | C |
| | Transfer sheet peelability | — | — | — | — |
| | Adhesion | A | C | — | A |
| | Maintaining of texture of substrate | ∘ | x | — | C |
| | Substrate color concealment | — | — | — | — |

Obviously, numerous modifications and variations of the present invention(s) are possible in light of the above teachings. It is therefore to be understood that within the scope of the appended claims, the invention(s) may be practiced otherwise than as specifically described herein.

What is claimed is:

1. An image forming method for forming an image on a substrate, the image forming method comprising:
forming a resin layer on the substrate;
adhering a transfer sheet having a sublimable dye ink layer on a surface thereof to the resin layer, the sublimable dye ink layer comprising a sublimable dye ink; and
heating the transfer sheet to transfer the sublimable dye ink to the resin layer,
wherein forming the resin layer comprises: ejecting a resin liquid from an inkjet head to adhere the resin liquid to the substrate, the resin liquid comprising a resin component capable of being polymerized by ultraviolet irradiation; and polymerizing the resin component by ultraviolet radiation to form the resin layer on the substrate.

2. The image forming method according to claim 1, wherein the substrate comprises an inorganic material or a resin material having a glass transition point of 90° C. or higher.

3. The image forming method according to claim 1, wherein the resin layer has a glass transition point in a range of 0° C. to 70° C.

4. The image forming method according to claim 1, wherein the resin layer has a thickness in a range of 5 μm to 50 μm.

5. The image forming method according to claim 1, wherein
the resin liquid comprises a first resin liquid which comprises a first resin component and a second resin liquid which comprises a second resin component,
forming the resin layer further comprises: ejecting the first resin liquid from an inkjet head to adhere the first resin liquid to the substrate; polymerizing the first resin component by ultraviolet irradiation to form a base layer on the substrate; ejecting the second resin liquid from an inkjet head to adhere the second resin liquid to the base layer; and polymerizing the second resin component by ultraviolet irradiation to form a surface layer on the base layer, and
the base layer has a glass transition point lower than a glass transition point of the surface layer.

6. The image forming method according to claim 5, wherein the first resin liquid further comprises a coloring material.

7. The image forming method according to claim 5, wherein
the glass transition point of the base layer is lower than 25° C., and
the glass transition point of the surface layer is in a range of 25° C. to 55° C.

8. The image forming method according to claim 7, wherein the surface layer has a thickness of 15 μm or more.

9. The image forming method according to claim 5, wherein
the resin liquid further comprises a third resin liquid, the third resin liquid comprising the second resin component and a coloring material,
neither the first resin liquid nor the second resin liquid comprises coloring material, and
forming resin layer further comprises: after polymerizing the first resin component before ejecting the second resin liquid, ejecting the third resin liquid from an inkjet head to adhere the third resin liquid to the base layer; and forming an intermediate layer between the base layer and the surface layer by ultraviolet irradiation.

10. The image forming method according to claim 1, wherein heating comprises heating the transfer sheet at a heating temperature in a range of 120° C. to 240° C. to transfer the sublimable dye ink to the resin layer.

11. The image forming method according to claim 2, wherein the resin layer has a glass transition point in a range of 0° C. to 70° C.

12. The image forming method according to claim 2, wherein the resin layer has a thickness in a range of 5 μm to 50 μm.

13. The image forming method according to claim 2, wherein
the resin liquid comprises a first resin liquid which comprises a first resin component and a second resin liquid which comprises a second resin component,
forming the resin layer further comprises: ejecting the first resin liquid from an inkjet head to adhere the first resin liquid to the substrate; polymerizing the first resin component by ultraviolet irradiation to form a base layer on the substrate; ejecting the second resin liquid from an inkjet head to adhere the second resin liquid to the base layer; and polymerizing the second resin component by ultraviolet irradiation to form a surface layer on the base layer, and
the base layer has a glass transition point lower than a glass transition point of the surface layer.

14. The image forming method according to claim 13, wherein the first resin liquid further comprises a coloring material.

15. The image forming method according to claim 13, wherein
the glass transition point of the base layer is lower than 25° C., and
the glass transition point of the surface layer is in a range of 25° C. to 55° C.

16. The image forming method according to claim 15, wherein the surface layer has a thickness of 15 μm or more.

17. The image forming method according to claim 13, wherein
the resin liquid further comprises a third resin liquid, the third resin liquid comprising the second resin component and a coloring material,
neither the first resin liquid nor the second resin liquid comprises coloring material, and
forming resin layer comprises: after polymerizing the first resin component before ejecting the second resin liquid, ejecting the third resin liquid from an inkjet head to adhere the third resin liquid to the base layer; and forming an intermediate layer between the base layer and the surface layer by ultraviolet irradiation.

18. The image forming method according to claim 2, wherein heating comprises heating the transfer sheet at a heating temperature in a range of 120° C. to 240° C. to transfer the sublimable dye ink to the resin layer.
